(19) United States
(12) Patent Application Publication
(10) Pub. No.: US 2016/0353088 A1
(43) Pub. Date: Dec. 1, 2016

(54) ALIGNING LAMINATION METHOD OF OPTICAL GRATING AND DISPLAY PANEL AND DEVICE

(71) Applicant: SHENZHEN CHINA STAR OPTOELECTRONICS TECHNOLOGY CO., Shenzhen, Guangdong (CN)

(72) Inventor: Qiaosheng LIAO, Shenzhen, Guangdong (CN)

(73) Assignee: SHENZHEN CHINA STAR OPTOELECTRONICS TECHNOLOGY CO., Shenzhen, Guangdong (CN)

(21) Appl. No.: 14/407,943

(22) PCT Filed: Dec. 2, 2014
(86) PCT No.: PCT/CN2014/092772

§ 371 Date: Dec. 12, 2014

(51) Int. Cl. H04N 13/04; G02B 27/22; G02B 5/18

(52) U.S. Cl. CPC H04N 13/0404; G02B 5/1847; G02B 5/1842; G02B 27/2214

(57) ABSTRACT

The present invention discloses an aligning lamination method of an optical grating and a display panel and a device. The method comprises: drawing a white line on a black picture and showing on the display panel, and a tilt angle of the white line is in accordance with a tilt angle designed for the optical grating; coating glue on the display panel, and the optical grating is located on the display panel; locating an image collecting apparatus in front of the display panel to collect images; adjusting a location angle of the optical grating and solidifying the glue to laminate the optical grating and the display panel as that the entire line is brightest is observed with the image collecting apparatus. With the foregoing arrangement, the present invention can simplify the aligning method of the optical grating and the display panel to make the accuracy high and the automatic process easy.

### FIELD OF THE INVENTION

The present invention relates to a display technology field, and more particularly to an aligning lamination method of an optical grating and a display panel and a device.

### BACKGROUND OF THE INVENTION

A 3D display is generally composed by laminating lenticular lens or slit optical grating with a 2D display. The 2D display is located at the focus position of the lenticular lens. Each lens covers several sub pixels. The light emitted by each sub pixel penetrates the lens and projects to various positions in space to form various viewpoints in the horizontal direction. When the left eye and the right eye are at different viewpoints, the binocular parallax effect makes human eyes feel the 3D effect.

The 3D display with excellent optical properties demands the complete accurate aligning angle when the optical grating and the display panel are laminated. The interferences at neither of top, middle or bottom of the display will be different if the laminating angle deviates from the design value and the interference of the entire panel is enhanced to seriously influence the watching result. For instance, as regarding the display of resolution 3840(RGB)*2160, the maximum deviation of the pixel is about eleven sub pixels if the aligning angle deviation is about 0.1°. A traditional aligning lamination method is: after lighting up the display panel and showing 3D test images, the glue is coated on the display panel and the optical grating is located on the display panel. The location angle of the optical grating will be adjusted by confirming whether different numbers are seen at different horizontal positions as watching the 3D panel at the best view distance, which is about three meters. If the result is yes, then, solidification and lamination are implemented. If the result is no, then, the location angle will be adjusted again. The glue is solidified for lamination for checking the result of lamination sample. The 3D display demands the lamination accuracy of the lamination device to reach the sub pixel level which the general lamination devices according to prior arts cannot satisfy such high accuracy.

### SUMMARY OF THE INVENTION

An objective of the present invention is to provide an aligning lamination method of an optical grating and a display panel and a device which can simplify the aligning method of the optical grating and the display panel to make the accuracy high and the automatic process easy.

For solving the aforesaid technical issues, the present invention provides an aligning lamination method of an optical grating and a display panel, comprising drawing a white line on a black picture and showing on the display panel, and a tilt angle of the white line is in accordance with a tilt angle designed for the optical grating; coating glue on the display panel, and the optical grating is located on the display panel; locating an image collecting apparatus in front of the display panel to collect images; adjusting a location angle of the optical grating and solidifying the glue to laminate the optical grating and the display panel as that the entire line is brightest is observed with the image collecting apparatus; wherein a width of the white line is at sub pixel level; the step of adjusting a location angle of the optical grating and solidifying the glue to laminate the optical grating and the display panel as that the entire line is brightest is observed with the image collecting apparatus further comprises: moving the white line to various locations of the black picture to adjust the location angle of the optical grating to observe that the entire line is brightest with the image collecting apparatus; solidifying the glue to laminate the optical grating and the display panel.

The step of moving the white line to various locations of the black picture to adjust the location angle of the optical grating to observe that the entire line is brightest with the image collecting apparatus comprises: moving the white line to a center of the black picture to adjust the location angle of the optical grating to observe that the entire line is brightest; moving the white line to a right side of the black picture to adjust the location angle of the optical grating to observe that the entire line is brightest.

The method applies to a slit optical grating.

For solving the aforesaid technical issues, the present invention provides an aligning lamination method of an optical grating and a display panel, comprising drawing a white line on a black picture and showing on the display panel, and a tilt angle of the white line is in accordance with a tilt angle designed for the optical grating; coating glue on the display panel, and the optical grating is located on the display panel; locating an image collecting apparatus in front of the display panel to collect images; adjusting a location angle of the optical grating and solidifying the glue to laminate the optical grating and the display panel as that the entire line is brightest is observed with the image collecting apparatus.

A width of the white line is at sub pixel level.

The step of adjusting a location angle of the optical grating and solidifying the glue to laminate the optical grating and the display panel as that the entire line is brightest is observed with the image collecting apparatus further comprises: moving the white line to various locations of the black picture to adjust the location angle of the optical grating to observe that the entire line is brightest with the image collecting apparatus; solidifying the glue to laminate the optical grating and the display panel.

The step of moving the white line to various locations of the black picture to adjust the location angle of the optical grating to observe that the entire line is brightest with the image collecting apparatus comprises: moving the white line to a center of the black picture to adjust the location angle of the optical grating to observe that the entire line is brightest; moving the white line to a right side of the black picture to adjust the location angle of the optical grating to observe that the entire line is brightest.

The method applies to a slit optical grating.

For solving the aforesaid technical issues, the present invention provides an aligning lamination device of an optical grating and a display panel, and the device comprises: a drawing module, employed to draw a white line on a black picture and showing on the display panel, and a tilt angle of the white line is in accordance with a tilt angle designed for the optical grating; an optical grating location module, connected to the drawing module and employed to coat glue on the display panel, and the optical grating is located on the display panel; a collecting module, connected to the optical grating location module and employed to locate an image collecting apparatus in front of the display panel to collect images; an adjusting module, connected to the optical grating location module and the collecting module, and employed to adjust a location angle of the optical grating and solidify the glue to laminate the optical grating and the display panel as that the entire line is brightest is observed with the image collecting apparatus.

A width of the white line is at sub pixel level.

The step of adjusting a location angle of the optical grating and solidifying the glue to laminate the optical grating and the display panel as that the entire line is brightest is observed with the image collecting apparatus further comprises: moving the white line to various locations of the black picture to adjust the location angle of the optical grating to observe that the entire line is brightest with the image collecting apparatus; solidifying the glue to laminate the optical grating and the display panel.

The step of moving the white line to various locations of the black picture to adjust the location angle of the optical grating to observe that the entire line is brightest with the image collecting apparatus comprises: moving the white line to a center of the black picture to adjust the location angle of the optical grating to observe that the entire line is brightest; moving the white line to a right side of the black picture to adjust the location angle of the optical grating to observe that the entire line is brightest.

The method applies to a slit optical grating.

With the aforesaid solutions, the benefits of the present invention are: by drawing a white line on a black picture, and a tilt angle of the white line is in accordance with a tilt angle designed for the optical grating and showing on the display panel; coating glue on the display panel, and the optical grating is located on the display panel; locating an image collecting apparatus in front of the display panel to collect images; adjusting a location angle of the optical grating and solidifying the glue to laminate the optical grating and the display panel as that the entire line is brightest is observed with the image collecting apparatus, the aligning method of the optical grating and the display panel can be simplified to make the accuracy high and the automatic process easy.

### BRIEF DESCRIPTION OF THE DRAWINGS

FIG. 1 is a flowchart of an aligning lamination method of an optical grating and a display panel according to the embodiment of the present invention;

FIG. 2 is a diagram of an aligning lamination method of an optical grating and a display panel according to the embodiment of the present invention;

FIG. 3 is a diagram of the optical grating and the display panel according to the embodiment of the present invention when the aligning angle is different;

FIG. 4 is a structural diagram of aligning lamination device of an optical grating and a display panel according to the embodiment of the present invention.

### DETAILED DESCRIPTION OF PREFERRED EMBODIMENTS

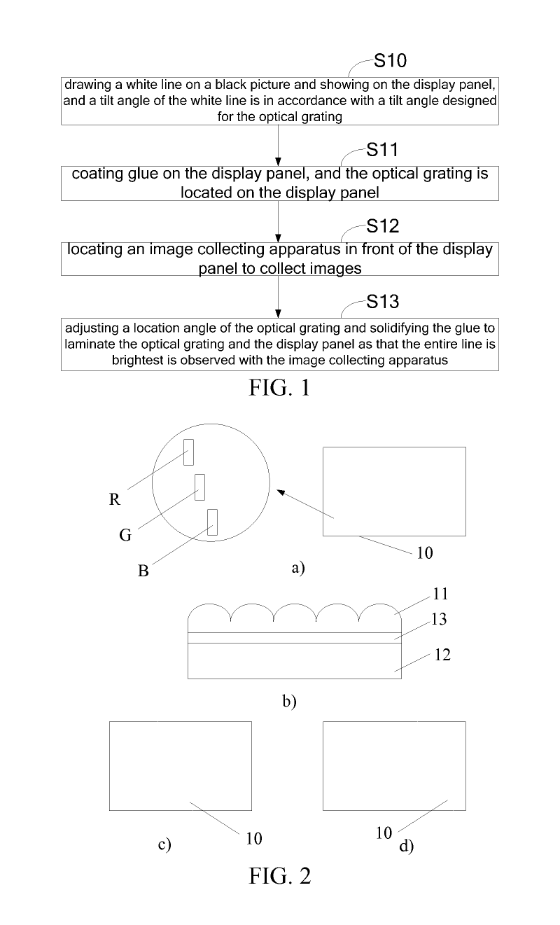

Please refer to FIG. 1. FIG. 1 is a flowchart of an aligning lamination method of an optical grating and a display panel according to the embodiment of the present invention. As shown in FIG. 1, an aligning lamination method of an optical grating and a display panel comprises

Step S10: drawing a white line on a black picture and showing on the display panel, and a tilt angle of the white line is in accordance with a tilt angle designed for the optical grating. As shown in portion (a) of FIG. 2, the left is the partial enlarged drawing, and R, G, B represent the sub pixels of the display panel. The tilt angle of the white line 10 and the tilt angle designed for the optical grating are identical and a width of the white line 10 is at sub pixel level.

Step S11: coating glue on the display panel, and the optical grating is located on the display panel. As shown in portion (b) of FIG. 2, glue 13 is coated on the display panel 12, and the optical grating 11 is located thereon. The next white line drawn on the black picture can be utilized for aligning the optical grating and the display panel, which is easy for adjustment, reservation and automatic process of the computer. The required time is short.

Step S12: locating an image collecting apparatus in front of the display panel to collect images. The image collecting apparatus can be a CCD (Charge-coupled Device) or other image collecting apparatuses, certainly. The aperture angle covers the entire display panel for observing the images collected by the image collecting apparatus.

Step S13: adjusting a location angle of the optical grating and solidifying the glue to laminate the optical grating and the display panel as that the entire line is brightest is observed with the image collecting apparatus.

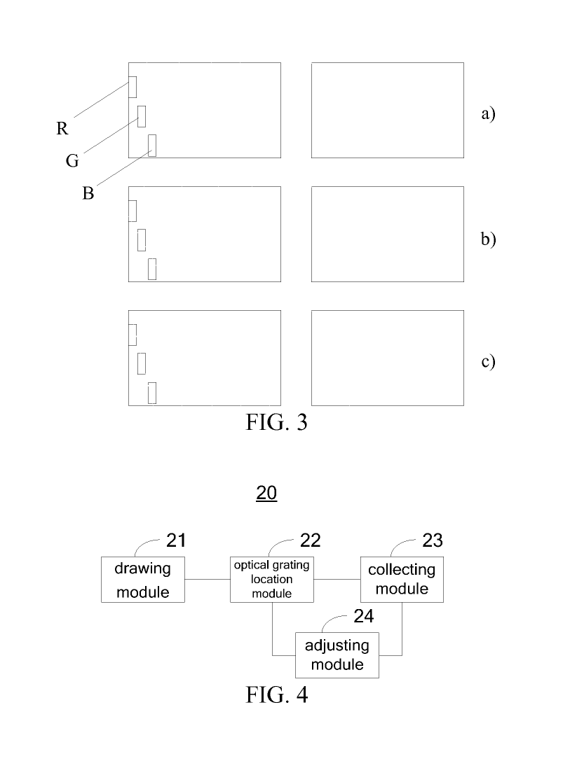

The brightness of the shown white line changes when the location angle of the optical grating is different. As shown in FIG. 3, the lefts represent the tilt angle of the white line and the tilt angle designed for the optical grating. The lines show the tilt angle of the optical grating, and R, G, B sub pixels show the tilt angle of the white line, i.e. the tilt angle designed for the optical grating and the width of the sub pixels. The rights present the brightness of the entire line observed with the image collecting apparatus. When the tilt angle of the optical grating completely matches with the white line, i.e. completely matches with the display panel, that the entire line becomes brightest will be observed with the image collecting apparatus and the brightness is uniform as shown in portion a. As the tilt angle of the optical grating deviates, a brightest line at neither of top, middle or bottom of the line will not be caught throughout as shown in portion b and portion c. The portion b shows that the tilt angle of the optical grating is too big. The portion c means that the tilt angle of the optical grating is too small. In the embodiment of the present invention, the computer can be utilized for confirming whether the brightness of the white line is maximum or not and is uniform or not to determine if the angle of the optical grating is completely matched and the mechanic automation can be realized. The image collecting apparatus, such as CCD, merely demands a general accuracy.

When the location angle of the optical grating is adjusted for observing that the entire line is brightest with the image collecting apparatus, furthermore, the white line is moved to various locations of the black picture to adjust the location angle of the optical grating to observe that the entire line with the image collecting apparatus is brightest too. Then, the glue is solidified to laminate the optical grating and the display panel. Specifically, the white line is moved to a center of the black picture to adjust the location angle of the optical grating to observe that the entire line is brightest, as shown in portion c of FIG. 2; the white line is moved to a right side of the black picture to adjust the location angle of the optical grating to observe that the entire line is brightest, as shown in portion c of FIG. 2.

The aligning lamination method of the optical grating and the display panel according to the embodiment of the present invention applies to a slit optical grating, similarly.

FIG. 4 is a structural diagram of aligning lamination device of an optical grating and a display panel according to the embodiment of the present invention. As shown in FIG. 4, an aligning lamination device 20 of an optical grating and a display panel comprises: a drawing module 21, an optical grating location module 22, collecting module 23 and an adjusting module 24. The drawing module 21 is employed to draw a white line on a black picture and showing on the display panel, and a tilt angle of the white line is in accordance with a tilt angle designed for the optical grating. The optical grating location module 22 is connected to the drawing module 21 and employed to coat glue on the display panel, and the optical grating is located on the display panel. The collecting module 23 is connected to the optical grating location module 22 and employed to locate an image collecting apparatus in front of the display panel to collect images. The adjusting module 24 is connected to the optical grating location module 22 and the collecting module 23, and employed to adjust a location angle of the optical grating and solidify the glue to laminate the optical grating and the display panel as that the entire line is brightest is observed with the image collecting apparatus.

In the embodiment of the present invention, a width of the white line is at sub pixel level. Thereby, the next white line drawn on the black picture can be utilized for aligning the optical grating and the display panel, which is easy for adjustment, reservation and automatic process of the computer. The required time is short. The image collecting apparatus can be a CCD or other image collecting apparatuses, certainly. The aperture angle covers the entire display panel for observing the images collected by the image collecting apparatus. The brightness of the shown white line changes when the location angle of the optical grating is different. The adjusting module 24 is further employed for: move the white line to various locations of the black picture to adjust the location angle of the optical grating to observe that the entire line is brightest with the image collecting apparatus; solidifying the glue to laminate the optical grating and the display panel. Specifically, the adjusting module 24 moves the white line to the center of the black picture to adjust the location angle of the optical grating to observe that the entire line is brightest. Then, the adjusting module 24 moves the white line to the right side of the black picture to adjust the location angle of the optical grating to observe that the entire line is brightest. In the embodiment of the present invention, the computer can be utilized for confirming whether the brightness of the white line is maximum or not and is uniform or not to determine if the angle of the optical grating is completely matched and the mechanic automation can be realized. The image collecting apparatus, such as CCD, merely demands a general accuracy.

The aligning lamination device 20 of the optical grating and the display panel according to the embodiment of the present invention applies to a slit optical grating.

In the embodiment of the present invention, the drawing module 21 draws a white line on a black picture and showing on the display panel, and a tilt angle of the white line is in accordance with a tilt angle designed for the optical grating. The optical grating location module 22 coats glue on the display panel, and the optical grating is located on the display panel. The collecting module 23 locates an image collecting apparatus in front of the display panel to collect images. The adjusting module 24 adjusts a location angle of the optical grating and solidify the glue to laminate the optical grating and the display panel as that the entire line is brightest is observed with the image collecting apparatus. The aligning method of the optical grating and the display panel can be simplified to make the accuracy high and the automatic process easy.

In conclusion, by drawing a white line on a black picture, and a tilt angle of the white line is in accordance with a tilt angle designed for the optical grating and showing on the display panel; coating glue on the display panel, and the optical grating is located on the display panel; locating an image collecting apparatus in front of the display panel to collect images; adjusting a location angle of the optical grating and solidifying the glue to laminate the optical grating and the display panel as that the entire line is brightest is observed with the image collecting apparatus, the present invention can simplify the aligning method of the optical grating and the display panel to make the accuracy high and the automatic process easy.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. An aligning lamination method of an optical grating and a display panel, wherein the method comprises:
drawing a white line on a black picture and showing on the display panel, and a tilt angle of the white line is in accordance with a tilt angle designed for the optical grating;
coating glue on the display panel, and the optical grating is located on the display panel;
locating an image collecting apparatus in front of the display panel to collect images;
adjusting a location angle of the optical grating and solidifying the glue to laminate the optical grating and the display panel as that the entire line is brightest is observed with the image collecting apparatus;
wherein a width of the white line is at sub pixel level;
the step of adjusting a location angle of the optical grating and solidifying the glue to laminate the optical grating and the display panel as that the entire line is brightest is observed with the image collecting apparatus further comprises: moving the white line to various locations of the black picture to adjust the location angle of the optical grating to observe that the entire line is brightest with the image collecting apparatus; solidifying the glue to laminate the optical grating and the display panel.

2. The method according to claim 1, wherein the step of moving the white line to various locations of the black picture to adjust the location angle of the optical grating to observe that the entire line is brightest with the image collecting apparatus comprises:
moving the white line to a center of the black picture to adjust the location angle of the optical grating to observe that the entire line is brightest;
moving the white line to a right side of the black picture to adjust the location angle of the optical grating to observe that the entire line is brightest.

3. The method according to claim 1, wherein the method applies to a slit optical grating.

4. An aligning lamination method of an optical grating and a display panel, wherein the method comprises:
drawing a white line on a black picture and showing on the display panel, and a tilt angle of the white line is in accordance with a tilt angle designed for the optical grating;
coating glue on the display panel, and the optical grating is located on the display panel;
locating an image collecting apparatus in front of the display panel to collect images;
adjusting a location angle of the optical grating and solidifying the glue to laminate the optical grating and the display panel as that the entire line is brightest is observed with the image collecting apparatus.

5. The method according to claim 5, wherein a width of the white line is at sub pixel level.

6. The method according to claim 4, wherein the step of adjusting a location angle of the optical grating and solidifying the glue to laminate the optical grating and the display panel as that the entire line is brightest is observed with the image collecting apparatus further comprises:
moving the white line to various locations of the black picture to adjust the location angle of the optical grating to observe that the entire line is brightest with the image collecting apparatus;
solidifying the glue to laminate the optical grating and the display panel.

7. The method according to claim 6, wherein the step of moving the white line to various locations of the black picture to adjust the location angle of the optical grating to observe that the entire line is brightest with the image collecting apparatus comprises:
moving the white line to a center of the black picture to adjust the location angle of the optical grating to observe that the entire line is brightest;
moving the white line to a right side of the black picture to adjust the location angle of the optical grating to observe that the entire line is brightest.

8. The method according to claim 4, wherein the method applies to a slit optical grating.

9. An aligning lamination device of an optical grating and a display panel, wherein the device comprises:
a drawing module, employed to draw a white line on a black picture and showing on the display panel, and a tilt angle of the white line is in accordance with a tilt angle designed for the optical grating;
an optical grating location module, connected to the drawing module and employed to coat glue on the display panel, and the optical grating is located on the display panel;
a collecting module, connected to the optical grating location module and employed to locate an image collecting apparatus in front of the display panel to collect images;
an adjusting module, connected to the optical grating location module and the collecting module, and employed to adjust a location angle of the optical grating and solidify the glue to laminate the optical grating and the display panel as that the entire line is brightest is observed with the image collecting apparatus.

10. The device according to claim 9, wherein a width of the white line is at sub pixel level.

11. The device according to claim 9, wherein the adjusting module is further employed for:
move the white line to various locations of the black picture to adjust the location angle of the optical grating to observe that the entire line is brightest with the image collecting apparatus;
solidifying the glue to laminate the optical grating and the display panel.

12. The device according to claim 11, wherein the adjusting module is employed for:
moving the white line to a center of the black picture to adjust the location angle of the optical grating to observe that the entire line is brightest;
moving the white line to a right side of the black picture to adjust the location angle of the optical grating to observe that the entire line is brightest.

13. The device according to claim 9, wherein the device applies to a slit optical grating.
